(19) United States
(12) Patent Application Publication
(10) Pub. No.: US 2026/0089581 A1
(43) Pub. Date: Mar. 26, 2026

(54) TECHNOLOGIES FOR RADIO LINK CONTROL ACKNOWLEDGED MODE IN A WIRELESS NETWORK

(71) Applicant: Apple Inc., Cupertino, CA (US)

(72) Inventors: Ping-Heng Kuo, London (GB); Haijing Hu, Los Gatos, CA (US); Ralf Rossbach, Munich (DE)

(73) Assignee: Apple Inc., Cupertino, CA (US)

(21) Appl. No.: 19/306,965

(22) Filed: Aug. 21, 2025

Related U.S. Application Data
(60) Provisional application No. 63/698,437, filed on Sep. 24, 2024.

(51) Int. Cl. H04W 36/00; H04L 69/322; H04W 28/02

(52) U.S. Cl. CPC H04W 36/0055; H04L 69/322; H04W 28/0278

(57) ABSTRACT

The present application relates to devices and components including apparatus, systems, and methods for radio link control (RLC) acknowledged mode (AM) in a wireless network.

### CROSS-REFERENCE TO RELATED APPLICATION

This application claims priority to U.S. Provisional Patent Application No. 63/698,437, entitled “TECHNOLOGIES FOR RADIO LINK CONTROL ACKNOWLEDGED MODE IN A WIRELESS NETWORK,” filed on Sep. 24, 2024, which is herein incorporated by reference in its entirety for all purposes.

### TECHNICAL FIELD

This application relates generally to communication networks and, in particular, to technologies for radio link control acknowledged mode in wireless networks.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example transmitter-initiated procedure to reduce radio link control (RLC) service data unit (SDU) retransmission in accordance with some embodiments.

FIG. 3 illustrates an example receiver-initiated procedure to reduce RLC SDU retransmission in accordance with some embodiments.

FIG. 4 illustrates an example combined procedure to reduce RLC SDU retransmission in accordance with some embodiments.

FIG. 5 illustrates an example procedure for data volume calculation in accordance with some embodiments.

FIG. 6 illustrates an example procedure in accordance with some embodiments.

FIG. 7 illustrates another example procedure in accordance with some embodiments.

FIG. 8 illustrates another example procedure in accordance with some embodiments.

FIG. 9 illustrates an operation flow/algorithmic structure in accordance with some embodiments.

FIG. 10 illustrates another operation flow/algorithmic structure in accordance with some embodiments.

FIG. 11 illustrates another operation flow/algorithmic structure in accordance with some embodiments.

FIG. 12 illustrates a user equipment in accordance with some embodiments.

FIG. 13 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

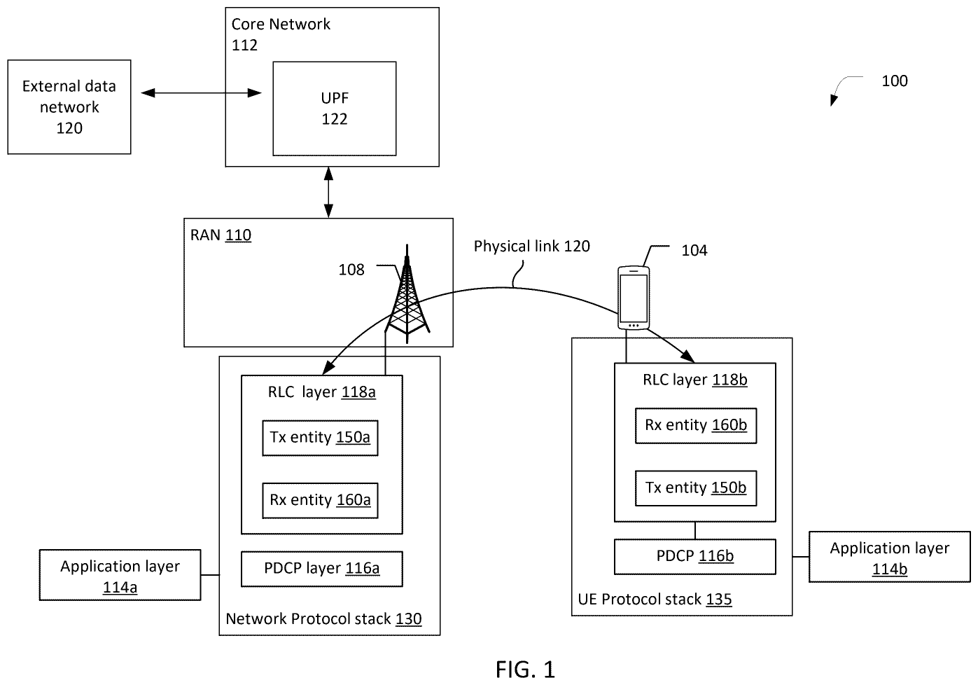

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

The network environment 100 may further include an external data network 120. The external data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

Operations described herein as performed by a device (for example, UE 104, base station 108, and/or a device of core network 112) may be fully, substantially, or partially performed by processing circuitry implemented on the device. Additionally, operations described herein as performed by “the network” may be performed by a device of the RAN 110 (e.g., base station 108), a device of the core network 112, and/or components thereof.

The core network 112 may include a user plane function (UPF) 122 that provides for routing and forwarding of user plane packets between the base station 108 and an external data network 120. The BS 108 may receive uplink packets from the UE 104 through the DRBs and may transmit the uplink packets to the UPF 122 through a general packet radio service (GPRS) tunneling protocol-user plane (GTP-U) tunnel. The UPF 122 may remove the packet headers and forward the packets to the external data network 120.

The UPF 122 may map downlink packets arriving from an external data network onto specific quality of service (QoS) flows belonging to specific PDU sessions before forwarding to the BS 108. The BS 108 may map the traffic to the appropriate DRBs for delivery to the UE 104.

The UE 104 may include an application layer 114 that generates application traffic to be transmitted to another device through the network environment 100. In some embodiments, the application layer may have an XR application that generates XR traffic. However, embodiments are not limited to XR use cases.

The 3GPP TSs may define a protocol stack, e.g., network protocol stack 130 or UE protocol stack 135. The protocol stack may be a set of communication protocols. In some examples, the protocol stack may be designed in a layered architecture for modularity, with each layer providing specific functions. The design may allow changes in one layer without affecting others, facilitating upgrades and improvements. The layers may include a physical layer (Layer 1, L1, or PHY) responsible for establishing and maintaining a physical link 120. Bits of control and data may transmit over the air interface and the physical link 120. The protocol stack, e.g., network protocol stack 130 or UE protocol stack 135, may include a data link layer (Layer 2, L2), which may be divided into a medium access control (MAC), a radio link control (RLC) 118a-b, and a packet data convergence protocol (PDCP) 116a-b sub-layers. Layer 2 may be responsible for managing the UE 104 connectivity and movement between cells and networks. In some instances, application layer 114a-b is not included in the protocol stack.

The RLC 118a-b sub-layer may be responsible for reliable data transmission. The RLC 118a-b may include a transmitting entity 150a-b and a receiving entity 160a-b. The transmitting entity 150a-b at the transmitting end may segment the data from higher layers, e.g., PDCP layer 116a-b or application layer 114a-b, and add sequence numbers and headers. These packets may then be transmitted over the air interface, e.g., via the physical link 120. At the receiver end, the receiving entity 160a-b of the RLC layer 118a-b may reassemble the packets back into the original data, e.g., using the sequence numbers and header information to ensure correct order and to detect any missing packets. If a packet is detected as missing or erroneous, the RLC layer 118a-b at the receiver can request retransmission from the transmitter.

In the downlink transmission, the base station 108 is the transmitting end, and the UE 104 is the receiving end. The transmitting entity 150a of the RLC 118a of the base station 108 sends the packets via the physical link 120 to the UE 104. The receiving entity 160b of the RLC layer 118b of the UE 104 receives and reassembles the packets. In some embodiments, the packet transmitted by an RLC layer 118a-b may be referred to as an RLC protocol data unit (PDU).

The receiving entity 160a of RLC layer 118a of the base station 108 may be called a peer entity to the transmitting entity 150b of RLC layer 118b of the UE 104. Similarly, the receiving entity 160b of RLC layer 118b of the UE 104 may be called a peer entity to the transmitting entity 150a of RLC layer 118a of the base station 108.

In some instances, a packet received by a layer from higher layers is called the service data unit (SDU) of that layer. The packet transmitted by the layer to lower layers is called the PDU of that layer. For example, packets received to PDCP layer 116a-b are called PDCP SDUs, and packets sent from PDCP layer 116a-b to RLC layer 118a-b are called PDCP PDUs.

The RLC layer 118a-b may be configured as an acknowledgment mode (AM) RLC. In AM RLC, each transmitted PDU is assigned a sequence number. The receiver may send acknowledgments (ACKs) for correctly received PDUs and negative acknowledgments (NACKs) for missing or erroneous PDUs. Upon receiving a NACK, or in the absence of an ACK associated with a PDU, the transmitter may retransmit the corresponding PDU.

In some embodiments, the application layer 114a-b may generate packets and group them in PDU sets. The PDCP layer 116a-b may receive the packets and generate PDCP PDUs. Each PDCP PDU may be associated with one or more application layer packets or a PDU set. The RLC layer 118a-b may receive the PDCP PDUs and generate RLC PDUs. Each RLC PDU may be associated with one or more PDCP PDUs and similarly may be associated with one or more application layer packets or a PDU set.

In some embodiments, when a PDCP SDU is received from the upper layer, the transmitting PDCP entity may start a discard timer. The discard timer may track the buffered time of each SDU at the PDCP layer 116a-b. In some instances, when the discard timer expires for a PDCP SDU, or the successful delivery of the PDCP SDU is confirmed, e.g., via an ACK, the transmitting PDCP entity may discard the PDCP SDU along with the corresponding PDCP PDU.

Each PDCP SDU may maintain its own discard timer. This is the case even for PDCP SDUs belonging to the same PDU set. A PDU set may include one or more PDUs carrying the payload of one unit of information generated at the application level (e.g. frame(s) or video slice(s) for XR Services). The PDCP SDUs belonging to the same PDU set do not necessarily arrive at the same time. This may be due to, for example, uplink (UL) jitter in tethered use cases, where packets experience different jitter before reaching the UE. Thus, each PDCP SDU may have different remaining times, even if they belong to the same PDU set. PDU set discarding may be configured when the application layer can only make use of a PDU set when all packets of the PDU Set are received. When PDU set discarding is configured, discard of one PDCP SDU may trigger discard of other PDCP SDUs of the same PDU set. To make sure data is useful for the application layer, it is beneficial for all packets of the PDU set to be transmitted immediately despite the remaining time of each individual PDCP SDU.

In some embodiments, RLC PDUs may be identified as delay-critical based on the discard timer of their respective PDCP PDUs. RLC layer 118a-b may prioritize the transmission or retransmission of delay-critical RLC PDUs. For example, the transmitting entity 150a-b may prioritize delay-critical AM data (AMD) RLC PDUs regardless of whether they are for initial transmission or retransmission.

The transmitting device may perform buffer status reporting (BSR) to report a data volume (including buffered RLC SDUs) that is awaiting transmission and/or delay status reporting (DSR) to report delay-critical data volume (including buffered delay-critical RLC SDUs). The BSR/DSR may be reported in an uplink MAC control element (CE). The data volume calculation for BSR and DSR is defined in 3GPP TS 38.322, Section 5.5, V18.1.0 (Jul. 12, 2024).

Under existing 3GPP specifications, the RLC layer 118a-b may continue to perform retransmission of a RLC SDU even after the packet corresponding to the RLC SDU is discarded. This may lead to delay in advancement of the transmission window at the transmit side and/or the reception window at the receive side, thereby causing transmission of newly arrived packets to be delayed. Additionally, the retransmissions unnecessarily use radio resources.

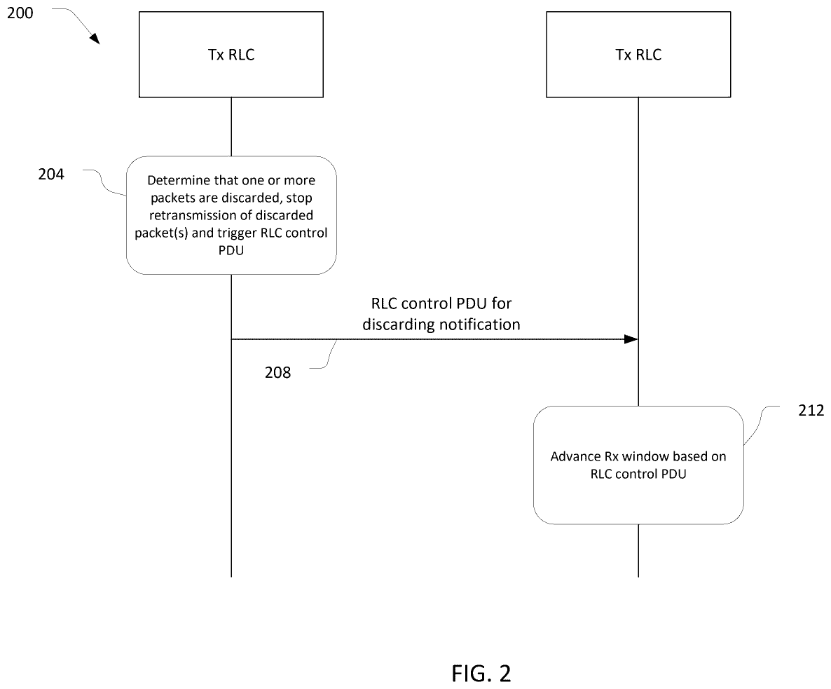

Some approaches have been developed to address unnecessary retransmission of RLC SDUs that are outdated (e.g., due to expiry of the discard timer for the corresponding PDCP SDU). FIG. 2 illustrates a transmitter-initiated procedure 200 in accordance with some embodiments. At 204 of the procedure 200, the transmit-side RLC (Tx RLC) determined that one or more packets are discarded (e.g., based on expiry of the associated discard timers). The Tx RLC stops retransmission of the one or more packets based on the determination. Additionally, the Tx RLC triggers a RLC control PDU (or another form of signaling) to notify the receive-side RLC (Rx RLC) that the one or more packets will no longer be retransmitted, as they are already discarded by the transmitter. For example, the RLC control PDU may include a bitmap, wherein individual bits represent a RLC SDU and the value of which (0 or 1) indicates whether the respective RLC SDU is discarded or not. At 208 of the procedure 200, the Tx RLC transmits the RLC control PDU to the Rx RLC. At 212 of the procedure 200, the Rx RLC advances the reception window based on the RLC control PDU.

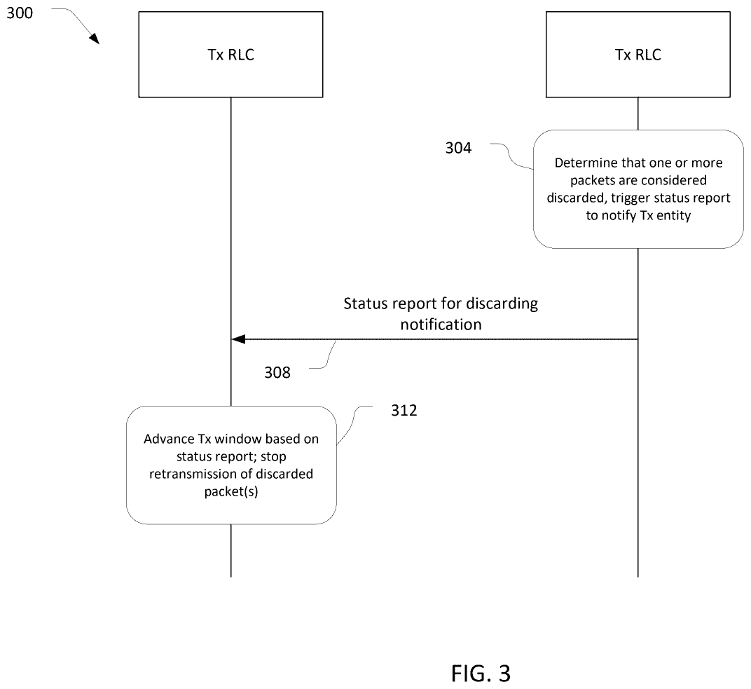

FIG. 3 illustrates a receiver-initiated procedure 300 in accordance with some embodiments. At 304 of the procedure 300, the Rx RLC determines that one or more packets are considered to be discarded by the Tx RLC. The determination may be made, for example, based on a timer or a counter of transmission failures. At 308 of the procedure 300, the Rx RLC may send a status report to the transmitter to identify the one or more packets that are determined to be discarded. At 312 of the procedure 300, the Tx RLC may stop retransmission of the one or more packets based on the status report (if not already stopped) and may advance the transmission window accordingly.

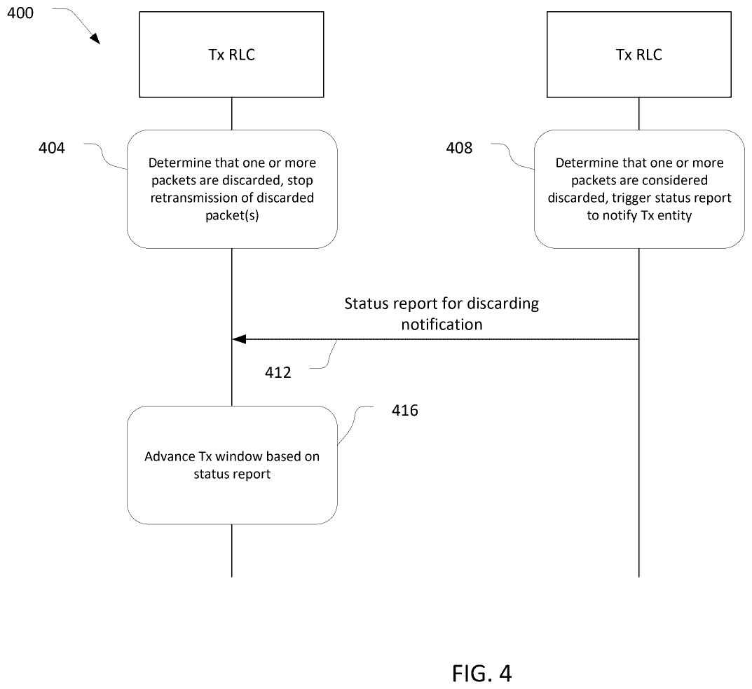

FIG. 4 illustrates a combined procedure 400 in accordance with some embodiments. The procedure 400 may combine aspects of procedure 200 and procedure 300. For example, at 404 of the procedure 400, the Tx RLC determines that one or more packets are discarded and stops retransmission of the one or more packets. At 408 of the procedure 400, the Rx RLC determines that one or more packets are considered to be discarded and triggers a status report to notify the Tx RLC. At 412, the Rx RLC transmits the status report to the Tx RLC. At 416 of the procedure 400, the Tx RLC advances the transmit window based on the status report.

Accordingly, tor the transmitter-initiated approach (e.g., as shown in FIG. 2), a new RLC control PDU may be transmitted from the transmitter to the receiver to notify the receiver of the one or more RLC SDUs that will no longer be retransmitted (e.g., that have been discarded). However, the RLC control PDU is not accounted for in current definitions of data volume calculation for BSR and DSR.

Additionally, for the receiver initiated approach (e.g., as shown in FIG. 3) and the combined approach (e.g., as shown in FIG. 4), the receiver sends a status report to the transmitter to advance the transmission window. The status report should be sent as soon as possible to synchronize the transmission and reception windows. However, if a prohibit timer is running (e.g., based on a prior transmission of a status report), then the receiver may need to wait for expiration of the prohibit timer before sending the status report, thus causing a delay.

On the other hand, triggering of autonomous retransmission of RLC SDUs without feedback has been conceived as a method to reduce the latency caused by RLC-AM operations. For instance, retransmission of a RLC SDU may be triggered autonomously by the Tx-RLC as soon as it becomes delay-critical, even if the Tx-RLC has not received the status feedback for the corresponding RLC SDU. Considering PDU Set discarding, when autonomous retransmission for a packet is triggered, it may also trigger autonomous retransmission for one or more other packets (e.g., all other packets) that belong to the same PDU set. This may enable all packets of the PDU set to be delivered more quickly, which may be especially important if PDU set discarding is configured. For example, when autonomous retransmission for a first RLC SDU is triggered, the Tx-RLC may also trigger autonomous retransmission for a second RLC SDU if both the first RLC SDU and the second RLC SDU belong to the same PDU Set, regardless of the remaining time till discarding of the second RLC SDU. Accordingly, there may be a surge of data volume for RLC PDUs that are pending for retransmission when retransmission for all PDUs of a PDU set is triggered. The UE may not have sufficient UL resources for the retransmission of the corresponding RLC SDUs, particularly since the network may not know whether (and how many) autonomous retransmissions have been triggered. Additionally, the autonomous retransmissions for large numbers of packets may cause a significant impact to network capacity.

Various embodiments herein address these issues among other features.

### Data Volume Calculation

In some embodiments, the data volume calculation for BSR and/or DSR may be modified based on one or more RLC SDUs (or segments thereof) that have been discarded and/or based on whether a RLC PDU has been triggered (and not yet transmitted) to notify the receive entity of the one or more discarded RLC SDUs. For example, when BSR and/or DSR is triggered, the UE as transmit entity may calculate an associated buffer data volume and/or delay-critical data volume, respectively.

In embodiments, the UE may identify one or more RLC SDUs (or segments thereof) that are pending for initial transmission or retransmission (e.g., that are stored in the transmission buffer) but that have been discarded by the PDCP layer. The UE may refrain from including the identified one or more RLC SDUs (or segments thereof) in the data volume calculation. The RLC layer may receive an indication from the associated PDCP layer to indicate the one or more RLC SDUs that are discarded. As discussed above, in some embodiments, the RLC layer may stop retransmission of the one or more RLC SDUs based on the indication from the PDCP layer. The RLC layer may delete the one or more RLC SDUs from the transmission buffer based on the indication. Accordingly, the RLC layer may manage the RLC SDUs that are considered as awaiting transmission or retransmission on an ongoing basis, and may not wait for a data volume calculation to be triggered.

Additionally, or alternatively, the UE may determine if a RLC control PDU for the discarding notification (e.g., to notify the receive entity of the one or more RLC SDUs that have been discarded) has been triggered by not yet transmitted. This may be relevant to transmitter-initiated procedure 200 for avoidance of unnecessary retransmission. If a RLC control PDU has been triggered by not yet transmitted, the UE may include the size of the RLC control PDU in the data volume calculation. Note that the RLC control PDU to notify the receive entity that one or more RLC SDUs will no longer be retransmitted may be referred to by any suitable name, such as “discarding notification” and/or “RLC sequence number (SN) gap notification.”

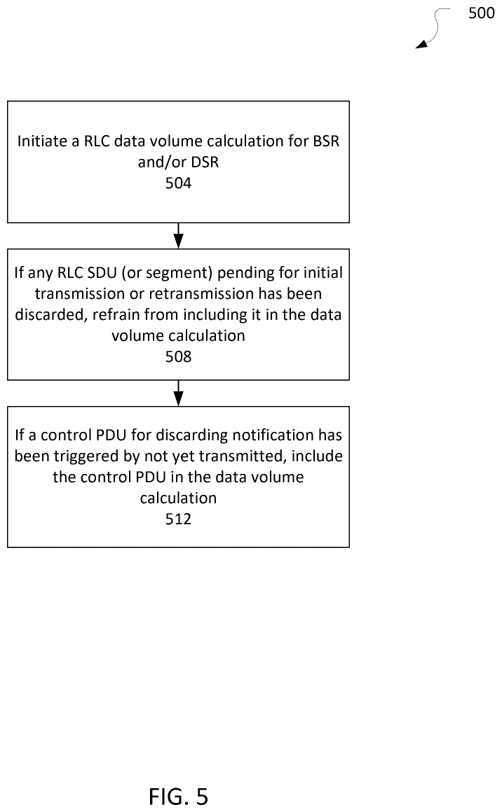

FIG. 5 illustrates an example procedure 500 for data volume calculation in accordance with some embodiments. The procedure 500 may be performed by a UE (e.g., UE 104) or components thereof.

At 504, the procedure 500 may include to initiate a RLC data volume calculation for BSR and/or DSR.

At 508, the procedure 500 may include to identify if any RLC SDU (or segment thereof) pending for initial transmission or retransmission has been discarded and refrain from including the identified RLC SDU (or segment) in the data volume calculation.

At 512, the procedure 500 may include to determine if a control PDU for a discarding notification has been triggered but not yet transmitted and, if so, include the control PDU in the data volume calculation. Note that the operations at 508 and 512 may be performed independently from one another in some embodiments. That is, the UE may perform operation 512 without also performing operation 508 in some embodiments.

In one example, 3GPP TS 38.322, Section 5.5, may be updated as follows to account for transmission of the RLC control PDU (additions in underline):

For the purpose of MAC buffer status reporting, the UE shall consider the following as RLC data volume:
RLC SDUs and RLC SDU segments that have not yet been included in an RLC data PDU;
RLC data PDUs that are pending for initial transmission;
RLC data PDUs that are pending for retransmission (RLC AM);
RLC control PDU for discarding notification that have not yet been transmitted.

For the purpose of MAC delay status reporting, the UE shall consider the following as delay-critical RLC data volume:
delay-critical RLC SDUs and delay-critical RLC SDU segments that have not yet been included in an RLC data PDU;
RLC data PDUs pending for initial transmission, and containing a delay-critical RLC SDU or a delay-critical RLC SDU segment;
RLC data PDUs that are pending for retransmission (RLC AM);
RLC control PDU for discarding notification that have not yet been transmitted.

### Status Report From Receiver

As discussed above, in the receiver-initiated approach (e.g., as shown in FIG. 3) and the combined approach (e.g., as shown in FIG. 4), the receive entity may send a status report to the transmit entity to indicate that one or more RLC SDUs are considered discarded by the transmit entity. The receive entity may determine that the RLC SDUs are discarded based on, for example, a timer. However, the transmit entity may currently have a prohibit timer running that is associated with transmission of status reports. For example, the prohibit timer may be started based on transmission of a prior status report, and the transmit entity is not supposed to send another status report until after expiration of the prohibit timer.

In various embodiments herein, if a status report for discard notification is triggered by the receive entity while a prohibit timer is running, the receive entity may still send the status report for discard notification (e.g., prior to expiration of the prohibit timer). In some embodiments, the receive entity may stop running the prohibit timer, transmit the status report while the probit timer is stopped, and then restart the prohibit timer after transmission of the status report. In other embodiments, the transmit entity may consider the prohibit timer as not applicable to status reports for discard notification. The prohibit timer may still apply to other types of status reports, e.g., for ACK/NACK feedback.

The receive entity and transmit entity may advance the respective reception and transmission window in accordance with the status report.

In some embodiments, the status report for discard notification may include an ACK for the one or more RLC SDUs that are considered discarded. In other embodiments, the status report may include a unique indicator (separate from the ACK) to indicate that the RLC SDUs are considered discarded. The transmit entity may stop retransmission of the one or more RLC SDUs based on the status report.

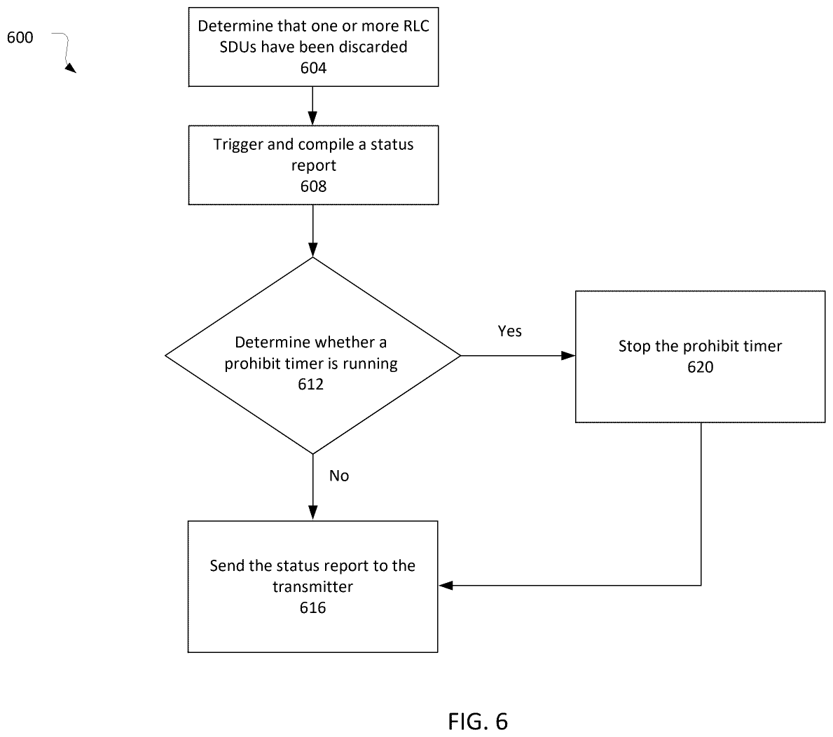

FIG. 6 illustrates an example procedure 600 in accordance with some embodiments. The procedure 600 may be performed by a receive entity, such as UE 104, base station 108, or components thereof.

At 604, the procedure 600 may include to determine that one or more RLC SDUs have been discarded. The determination may be made, e.g., based on a timer.

At 608, the procedure 600 may include to generate a status report based on the determination. In some embodiments, the status report may include an ACK for the one or more RLC SDUs that are determined to have been discarded.

At 612, the procedure 600 may include to determine if a prohibit timer for status reports is running. If a prohibit timer is not running, then at 616 the procedure 600 may include to send the status report to the transmitter. The receive entity may further start the prohibit timer based on transmission of the status report.

If it is determined at 612 that a prohibit timer is running, then at 620 the procedure 600 may include to stop the prohibit timer. The procedure 600 may then proceed to block 616 at which the status report is sent to the transmitter. The receive entity may further restart the prohibit timer (e.g., start over or restart from the time at which it was stopped at 620).

Accordingly, the procedure 600 may enable the status report for discard notification to be transmitted more quickly, without waiting for expiration of the prohibit timer.

### BSR/DSR Triggering Based on Autonomous RLC Retransmission

Embodiments may include techniques to trigger BSR and/or DSR based on autonomous RLC retransmission. For example, the transmit entity (e.g., UE and/or base station) may determine a number of RLC SDUs and/or a data volume based on one or more RLC SDUs (or segments thereof) for which autonomous retransmission has been triggered and may trigger BSR and/or DSR based on the number and/or data volume (e.g., based on a determination that the number and/or data volume exceeds a corresponding threshold). The threshold may be zero or a positive, non-zero value.

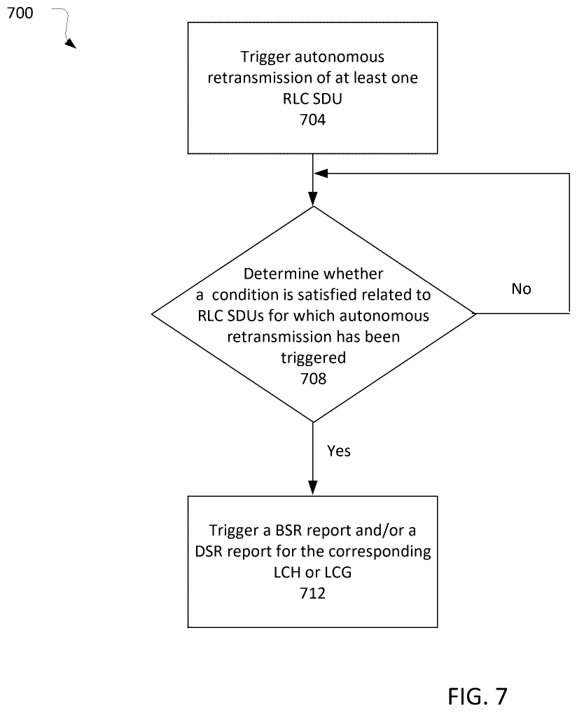

FIG. 7 illustrates an example procedure 700 for triggering BSR and/or DSR in accordance with some embodiments. The procedure 700 may be performed by a transmit entity (e.g., a UE, such as UE 104, and/or a base station, such as base station 108, or components thereof).

At 704, the procedure 700 may include to trigger autonomous retransmission of at least one RLC SDU. In some embodiments, autonomous retransmission for a first RLC SDU may be triggered if it has been submitted to a lower layer for transmission, a positive acknowledgment (ACK) has not yet been received, and the associated remaining time until discard has dropped below a threshold. In some embodiments, a second RLC SDU may also be triggered for autonomous retransmission if the second RLC SDU belongs to the same PDU set as the first RLC SDU and the second RLC SDU has been submitted to a lower layer for transmission and not yet positively acknowledged (e.g., an ACK has not been received).

At 708, the procedure 700 may include to determine whether a condition is satisfied related to one or more RLC SDUs that have been triggered for autonomous retransmission and still pending. If the condition is satisfied, the procedure 700 may include, at 712, to trigger a BSR and/or DSR report. The BSR and/or DSR report may be triggered for the corresponding LCH and/or LCG.

In one example, the transmit entity may determine a number of RLC SDUs (or segments thereof) for which autonomous retransmission has been triggered and is still pending (not yet transmitted) since the last BSR/DSR report for the corresponding LCH and/or LCG. The transmit entity may trigger a BSR and/or DSR report based on the determined number exceeding a threshold (which may be zero or a positive, non-zero value).

In another example, the transmit entity may determine a total data volume of RLC SDUs (or segments thereof) for which autonomous retransmission has been triggered and is still pending (not yet transmitted) since the last BSR/DSR report for the corresponding LCH and/or LCG. The transmit entity may trigger a BSR and/or DSR report based on the determined data volume exceeding a threshold (which may be zero or a positive, non-zero value).

In another example, the transmit entity may determine a number of one or more delay-critical RLC SDUs (or segments thereof) for which autonomous retransmission has been triggered and is still pending (not yet transmitted) since the last BSR/DSR report for the corresponding LCH and/or LCG. The transmit entity may trigger a BSR and/or DSR report based on the determined number exceeding a threshold (which may be zero or a positive, non-zero value). In some embodiments, the transmit entity may additionally or alternatively determine the number of important RLC SDUs (e.g., with an importance level of at least a threshold importance) for which autonomous retransmission has been triggered and still pending. For example, the transmit entity may determine a total number of delay-critical RLC SDUs and important RLC SDUs and trigger a BSR and/or DSR report based on the total number being greater than a corresponding threshold.

In another example, the transmit entity may determine a total data volume of delay-critical RLC SDUs (or segments thereof) for which autonomous retransmission has been triggered and is still pending (not yet transmitted) since the last BSR/DSR report for the corresponding LCH and/or LCG. The transmit entity may trigger a BSR and/or DSR report based on the determined number exceeding a threshold (which may be zero or a positive, non-zero value). In some embodiments, the transmit entity may additionally or alternatively determine the data volume of important RLC SDUs (e.g., with an importance level of at least a threshold importance) for which autonomous retransmission has been triggered and still pending. For example, the transmit entity may determine a total data volume of delay-critical RLC SDUs and important RLC SDUs and trigger a BSR and/or DSR report based on the total data volume being greater than a corresponding threshold.

### Constraints on Autonomous RLC Retransmission

In some embodiments, the transmit entity may trigger autonomous RLC retransmission subject to one or more constraints (e.g., limits). In some embodiments, the network may configure the one or more constraints for the UE.

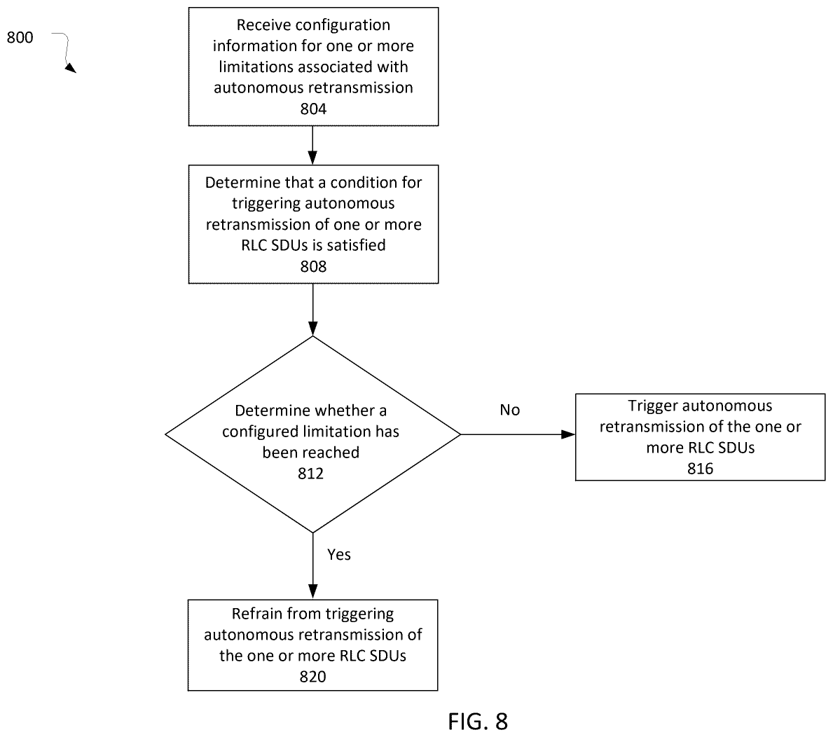

FIG. 8 illustrates an example procedure 800 in accordance with various embodiments. The procedure 800 may be performed by a transmit entity (e.g., a UE, such as UE 104, or a component thereof). Although the procedure 800 is described with respect to the transmit entity being a UE, aspects of the procedure 800 may also be performed when the transmit entity is a base station (e.g., base station 108 or a component thereof).

At 804, the procedure 800 may include to receive configuration information for one or more limitations associated with autonomous RLC retransmission. In some embodiments, the configuration information may indicate a maximum number of times that a RLC SDU can be considered for retransmission autonomously. For example, a RLC SDU may be autonomously retransmitted up to N times. After N retransmissions, the RLC SDU may no longer be considered for autonomous retransmission even if the conditions for autonomous retransmission are satisfied. In some embodiments, the configuration information may indicate a maximum number of RLC SDUs of a given PDU set that may be considered for retransmission autonomously. For example, if multiple RLC SDUs of a PDU set satisfy the conditions for autonomous retransmission simultaneously, the transmit entity may trigger autonomous retransmission for a subset of the RLC SDUs (e.g., N RLC SDUs, where N is indicated by the configuration information). In some embodiments, the configuration information may indicate a maximum number of RLC SDUs that may be pending for retransmission at the same time. For example, if there are already the maximum number of RLC SDUs pending for retransmission then the transmit entity may not trigger autonomous retransmission for an additional RLC SDU even if the conditions are satisfied.

In some embodiments, the configuration information may configure a prohibit timer for autonomous retransmission. For example, the transmit entity may start the prohibit timer based on triggering autonomous retransmission for one or more RLC SDUs or performing the autonomous retransmission. The transmit entity may not trigger or perform autonomous retransmission for the same RLC SDU or another RLC SDU until after the prohibit timer expires. The length of the prohibit timer and/or conditions for starting the prohibit timer (e.g., number of autonomous retransmissions to trigger starting the prohibit timer) may be configured for the UE via the configuration information. The prohibit timer may be operated per RLC SDU (e.g., one prohibit timer is running for each RLC SDU) or per RLC entity (e.g., one prohibit timer is running for all RLC SDUs).

At 808, the procedure 800 may include to determine that a condition for triggering autonomous retransmission of one or more RLC SDUs is satisfied. In some embodiments, autonomous retransmission for a first RLC SDU may be triggered if it has been submitted to a lower layer for transmission, a positive acknowledgment (ACK) has not yet been received, and the associated remaining time until discard has dropped below a threshold. In some embodiments, a second RLC SDU may also be triggered for autonomous retransmission if the second RLC SDU belongs to the same PDU set as the first RLC SDU and the second RLC SDU has been submitted to a lower layer for transmission and not yet positively acknowledged (e.g., an ACK has not been received).

At 812, the procedure 800 may include to determine whether a configured limitation of the one or more configured limitations has been reached. If a limitation has not been reached, the procedure 800 may include, at 816, to trigger autonomous retransmission of the one or more RLC SDUs. If the limitation has been reached, the procedure 800 may include, at 820, to refrain from triggering autonomous retransmission of the one or more RLC SDUs.

In some embodiments, the transmit entity may re-check whether the one or more limitations have been reached at a later time and may trigger retransmission of the one or more RLC SDUs at that time if the one or more limitations are no longer met. In other embodiments, the one or more RLC SDUs may not be retransmitted further (e.g., if the discard timer expires prior to the limitation being no longer met).

### Cancellation of Autonomous Retransmission

In some embodiments, the transmit entity may trigger an autonomous retransmission for a RLC SDU but may receive a positive acknowledgment (ACK) before the retransmission is performed. Under these circumstances, the transmit entity may cancel the autonomous retransmission. For example, the transmit entity may remove the RLC SDU from a transmission (or retransmission) buffer.

Example updates to 3GPP TS 38.322, Section 5.2.3.1.1 are shown below (additions in underline):

When receiving a positive acknowledgement for an RLC SDU with SN=x, the transmitting side of an AM RLC entity shall:
send an indication to the upper layers of successful delivery of the RLC SDU;
set TX_Next_Ack equal to the SN of the RLC SDU with the smallest SN, whose SN falls within the range TX_Next_Ack<=SN<=TX_Next and for which a positive acknowledgement has not been received yet;
stop considering the RLC SDU as pending for retransmission (e.g., if autonomous retransmission of this RLC SDU was triggered previously)

### Example Operation Flows/Algorithmic Structures

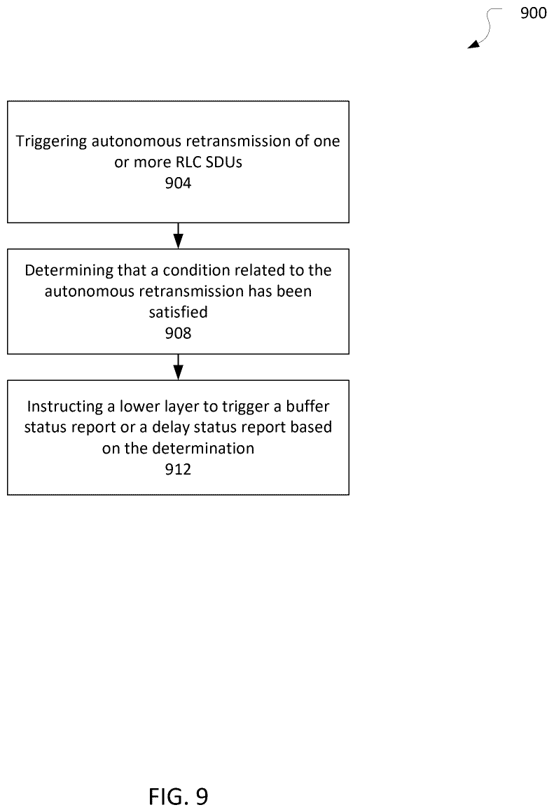

FIG. 9 illustrates an operation flow/algorithmic structure 900 in accordance with some embodiments. The operation flow/algorithmic structure 900 may be performed by a UE, such as UE 104, UE 1200, or components therein, for example, baseband processor 1204A.

The operation flow/algorithmic structure 900 may include, at 904, triggering autonomous retransmission of one or more RLC SDUs. In some embodiments, autonomous retransmission for a first RLC SDU may be triggered if it has been submitted to a lower layer for transmission, a positive acknowledgment (ACK) has not yet been received, and the associated remaining time until discard has dropped below a threshold. In some embodiments, a second RLC SDU may also be triggered for autonomous retransmission if the second RLC SDU belongs to the same PDU set as the first RLC SDU and the second RLC SDU has been submitted to a lower layer for transmission and not yet positively acknowledged (e.g., an ACK has not been received).

The operation flow/algorithmic structure 900 may further include, at 908, determining that a condition related to the autonomous retransmission has been satisfied. The condition may include, for example, that a number or data volume of RLC SDUs (or segments thereof) for which autonomous retransmission has been triggered and is still pending since the last BSR/DSR report for the corresponding LCH or LCG exceeds a threshold; that a number or data volume of delay-critical RLC SDUs (or segments thereof) for which autonomous retransmission has been triggered and is still pending since the last BSR/DSR report for the corresponding LCH or LCG exceeds a threshold; and/or that a number or data volume of delay-critical and important RLC SDUs (or segments thereof) for which autonomous retransmission has been triggered and is still pending since the last BSR/DSR report for the corresponding LCH or LCG exceeds a threshold.

The operation flow/algorithmic structure 900 may further include, at 912, instructing a lower layer to trigger a buffer status report or a delay status report based on the determination.

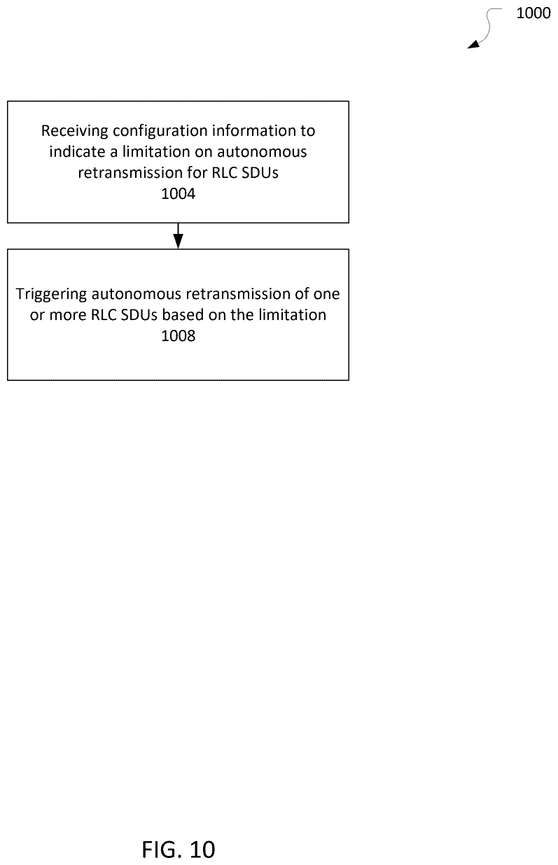

FIG. 10 illustrates another operation flow/algorithmic structure 1000 in accordance with some embodiments. The operation flow/algorithmic structure 1000 may be performed by a UE, such as UE 104, UE 1200, or components therein, for example, baseband processor 1204A.

The operation flow/algorithmic structure 1000 may include, at 1004, receiving configuration information to indicate a limitation on autonomous retransmission for RLC SDUs. The operation flow/algorithmic structure 1000 may further include, at 1008, triggering autonomous retransmission of one or more RLC SDUs based on the limitation.

In some embodiments, the configuration information may indicate a maximum number of times that a RLC SDU can be considered for retransmission autonomously. For example, a RLC SDU may be autonomously retransmitted up to N times. After N retransmissions, the RLC SDU may no longer be considered for autonomous retransmission even if the conditions for autonomous retransmission are satisfied. In some embodiments, the configuration information may indicate a maximum number of RLC SDUs of a given PDU set that may be considered for retransmission autonomously. For example, if multiple RLC SDUs of a PDU set satisfy the conditions for autonomous retransmission simultaneously, the transmit entity may trigger autonomous retransmission for a subset of the RLC SDUs (e.g., N RLC SDUs, where N is indicated by the configuration information). In some embodiments, the configuration information may indicate a maximum number of RLC SDUs that may be pending for retransmission at the same time. For example, if there are already the maximum number of RLC SDUs pending for retransmission then the transmit entity may not trigger autonomous retransmission for an additional RLC SDU even if the conditions are satisfied.

In some embodiments, the configuration information may configure a prohibit timer for autonomous retransmission. For example, the transmit entity may start the prohibit timer based on triggering autonomous retransmission for one or more RLC SDUs or performing the autonomous retransmission. The transmit entity may not trigger or perform autonomous retransmission for another RLC SDU until after the prohibit timer expires. The length of the prohibit timer and/or conditions for starting the prohibit timer (e.g., number of autonomous retransmissions to trigger starting the prohibit timer) may be configured for the UE via the configuration information.

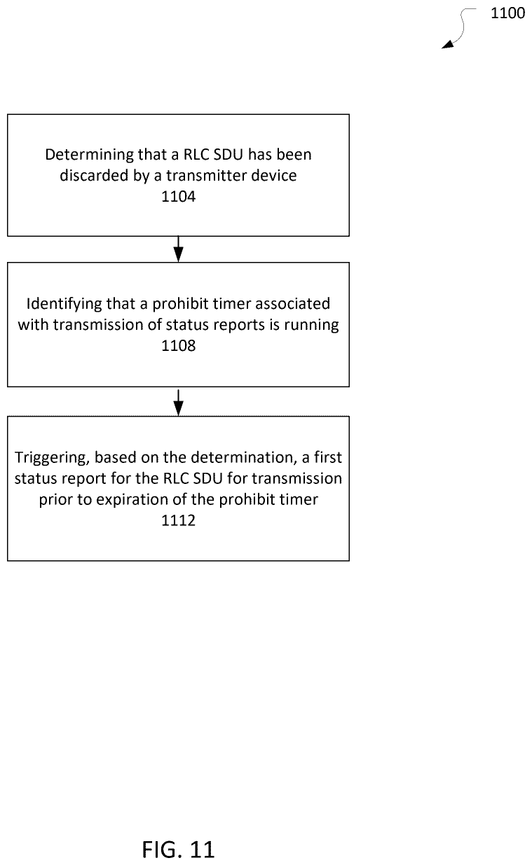

FIG. 11 illustrates another operation flow/algorithmic structure 1100 in accordance with some embodiments. The operation flow/algorithmic structure 1100 may be performed by a receive entity, e.g., a UE, such as UE 104, UE 1200, or components therein, for example, baseband processor 1204A; and/or a base station, such as base station 108, network device 1300, or components therein, for example baseband processor 1304A.

The operation flow/algorithmic structure 1100 may include, at 1104, determining that a RLC SDU has been discarded by a transmitter device. In one example, the determination may be based on one or more timers.

The operation flow/algorithmic structure 1100 may further include, at 1108, identifying that a prohibit timer associated with transmission of status reports is running. For example, the prohibit timer may be started based on transmission of a prior status report (e.g., to include ACK/NACK information for other RLC SDUs).

The operation flow/algorithmic structure 1100 may further include, at 1112, triggering, based on the determination, a first status report for the RLC SDU for transmission prior to expiration of the prohibit timer. In some embodiments, the prohibit timer may be stopped to enable the first status report to be transmitted. The prohibit timer may be started/restarted based on the transmission of the first status report.

### Example Devices

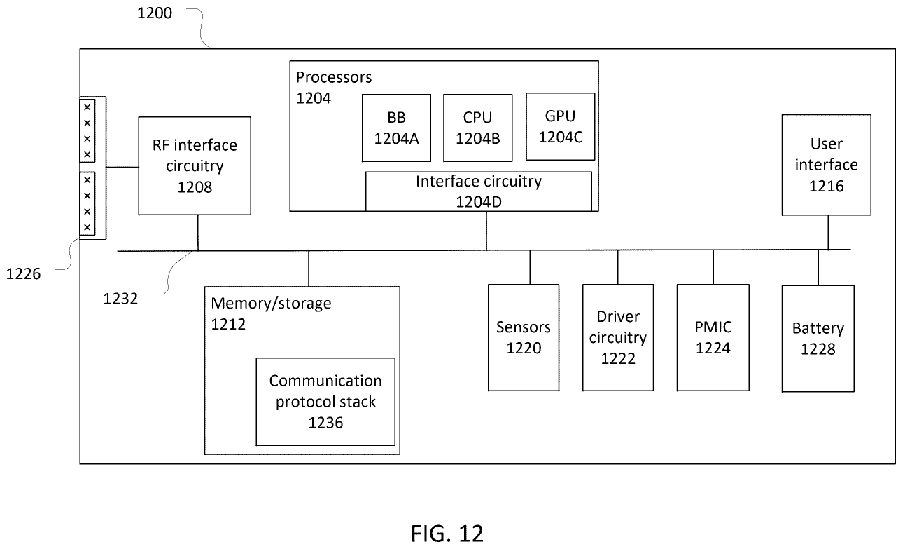

FIG. 12 illustrates a UE 1200 in accordance with some embodiments. The UE 1200 may be similar to and substantially interchangeable with UE 104.

The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1200 may include processors 1204, RF interface circuitry 1208, memory/storage 1212, user interface 1216, sensors 1220, driver circuitry 1222, power management integrated circuit (PMIC) 1224, antenna 1226, and battery 1228. The components of the UE 1200 may be implemented as integrated circuits (ICs), portions thereof, discrete electronic devices, or other modules, logic, hardware, software, firmware, or a combination thereof. In some embodiments, the RF interface circuitry 1208 may be included in the processors 1204. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations associated with RLC AM as described herein. The processors 1204 may also include interface circuitry 1204D to enable communication by, for example, communicatively coupling the processor circuitry with one or more other components of the UE 1200.

In some embodiments, the baseband processor 1204A may access a communication protocol stack 1236 in the memory/storage 1212 to communicate over a 3GPP compatible network. In general, the baseband processor 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform operations associated with RLC AM as described herein.

The memory/storage 1212 includes any type of volatile or non-volatile memory that may be distributed throughout the UE 1200. In some embodiments, some of the memory/storage 1212 may be located on the processors 1204 themselves (for example, memory/storage 1212 may be part of a chipset that corresponds to the baseband processor 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensors 1220 and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

A battery 1228 may power the UE 1200, although in some examples the UE 1200 may be mounted deployed in a fixed location and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

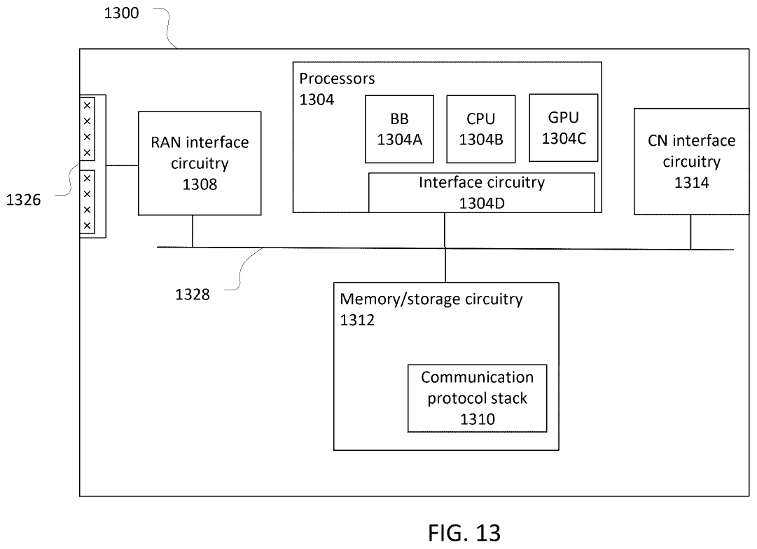

FIG. 13 illustrates a network device 1300 in accordance with some embodiments. The network device 1300 may be similar to, and substantially interchangeable with, the base station 108.

The network device 1300 may include processors 1304, RF interface circuitry 1308 (if implemented as a base station), core network (CN) interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage circuitry 1312 to cause the network device 1300 to perform operations associated with RLC AM as described herein. The processors 1304 may also include interface circuitry 1304D to communicatively couple the processor circuitry with one or more other components of the network device 1300.

The CN interface circuitry 1314 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: triggering autonomous retransmission of one or more radio link control (RLC) service data units (SDUs); determining that a condition related to the autonomous retransmission has been satisfied; and instructing a lower layer to trigger a buffer status report or a delay status report based on the determination.

Example 2 includes the method of example 1 or some other example herein, wherein the condition includes that a number or a data volume of the one or more RLC SDUs exceeds a threshold.

Example 3 includes the method of example 1 or some other example herein, wherein the condition includes that a number or a data volume of delay-critical SDUs of the one or more RLC SDUs exceeds a threshold, wherein the delay-critical SDUs have a remaining time to discard that is less than a remaining time threshold.

Example 4 includes the method of example 1 or some other example herein, wherein the condition includes that a total number or a total data volume of delay-critical SDUs and important SDUs of the one or more RLC SDUs exceeds a threshold, wherein the delay-critical SDUs have a remaining time to discard that is less than a remaining time threshold and the important SDUs have at least a threshold importance level.

Example 5 includes the method of example 1 or some other example herein, further comprising determining a data volume for the buffer status report or the delay status report, the data volume to include a RLC control protocol data unit (PDU) that indicates one or more RLC SDUs that will no longer be retransmitted.

Example 6 includes the method of example 1 or some other example herein, further comprising determining a data volume for the buffer status report or the delay status report, the data volume to exclude one or more RLC SDUs that will no longer be retransmitted.

Example 7 includes the method of example 1 or some other example herein, further comprising: receiving configuration information to indicate a limitation on autonomous retransmission for RLC service data units SDUs, wherein the triggering autonomous retransmission of one or more RLC SDUs is based on the limitation.

Example 8 includes the method of example 7 or some other example herein, wherein the limitation includes: a maximum number of times that a RLC SDU can be autonomously retransmitted; a maximum number of RLC SDUs of a protocol data unit (PDU) set that may be simultaneously triggered for autonomous retransmission; a maximum number of RLC SDUs that can be pending for autonomous retransmission at the same time; or a prohibit timer to control a frequency of autonomous retransmission of the one or more RLC SDUs.

Example 9 includes a method comprising: receiving configuration information to indicate a limitation on autonomous retransmission for radio link control (RLC) service data units (SDUs); and triggering autonomous retransmission of one or more RLC SDUs based on the limitation.

Example 10 includes the method of example 9 or some other example herein, wherein the limitation includes a maximum number of times that a RLC SDU can be autonomously retransmitted.

Example 11 includes the method of example 9 or some other example herein, wherein the limitation includes a maximum number of RLC SDUs of a protocol data unit (PDU) set that may be simultaneously triggered for autonomous retransmission.

Example 12 includes the method of example 9 or some other example herein, wherein the limitation includes a maximum number of RLC SDUs that can be pending for autonomous retransmission at the same time.

Example 13 includes the method of example 9 or some other example herein, wherein the limitation includes configuration information for a prohibit timer to control a frequency of autonomous retransmission of the one or more RLC SDUs.

Example 14 includes the method of example 9 or some other example herein, wherein triggering autonomous retransmission of the one or more RLC SDUs includes triggering autonomous retransmission of a first RLC SDU, and wherein the method further comprises: receiving an acknowledgement for the first RLC SDU after triggering autonomous retransmission of the first RLC SDU; and cancelling the autonomous retransmission of the first RLC SDU based on the acknowledgement.

Example 15 includes the method of example 9 or some other example herein, further comprising: determining that a condition related to the autonomous retransmission has been satisfied; and generating a buffer status report or a delay status report for transmission based on the determination, wherein the condition includes that: a number or a data volume of the one or more RLC SDUs exceeds a first threshold; a number or a data volume of delay-critical SDUs of the one or more RLC SDUs exceeds a second threshold, wherein the delay-critical SDUs have a remaining time to discard that is less than a remaining time threshold; or a total number or a total data volume of delay-critical SDUs and important SDUs of the one or more RLC SDUs exceeds a third threshold, wherein the important SDUs have at least a threshold importance level.

Example 16 includes a method comprising: determining that a radio link control (RLC) service data unit (SDU) has been discarded by a transmitter device; identifying that a prohibit timer associated with transmission of status reports is running; and triggering, based on the determination, a first status report for the RLC SDU for transmission prior to expiration of the prohibit timer.

Example 17 includes the method of example 16 or some other example herein, wherein the first status report includes an acknowledgement for the RLC SDU.

Example 18 includes the method of example 16 or some other example herein, further comprising stopping the prohibit timer based on the determination.

Example 19 includes the method of example 16 or some other example herein, further comprising restarting the prohibit timer based on transmission of the first status report.

Example 20 includes the method of example 16 or some other example herein, further comprising starting the prohibit timer based on transmission of a second status report prior to first status report.

Example 21 includes a method comprising: triggering a radio link control (RLC) protocol data unit (PDU) to indicate that one or more RLC service data units (SDUs) that will not be retransmitted; determining a data volume for a buffer status report or a delay status report, wherein the data volume includes the RLC PDU that has been triggered and not yet transmitted; and triggering transmission of the buffer status report or the delay status report.

Example 22 includes the method of example 21 or some other example herein, wherein the data volume excludes the one or more RLC SDUs that will not be retransmitted.

Example 23 includes a method comprising: triggering autonomous retransmission of a radio link control (RLC) service data unit (SDU); receiving an acknowledgement for the RLC SDU after triggering autonomous retransmission of the RLC SDU; and cancelling the autonomous retransmission of the RLC SDU based on the acknowledgement.

Example 24 includes the method of example 23 or some other example herein, wherein triggering the autonomous retransmission of the RLC SDU is based on a determination that the RLC SDU has a time remaining until discard below a threshold.

Another example may include an apparatus comprising means to perform one or more elements of a method described in or related to any of examples 1-24, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Another example may include an apparatus comprising logic, modules, or circuitry to perform one or more elements of a method described in or related to any of examples 1-24, or any other method or process described herein.

Another example may include a method, technique, or process as described in or related to any of examples 1-24, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-24, or portions thereof.

Another example may include a signal as described in or related to any of examples 1-24, or portions or parts thereof.

Another example may include a datagram, information element, packet, frame, segment, PDU, or message as described in or related to any of examples 1-24, or portions or parts thereof, or otherwise described in the present disclosure.

Another example may include a signal encoded with data as described in or related to any of examples 1-24, or portions or parts thereof, or otherwise described in the present disclosure.

Another example may include a signal encoded with a datagram, IE, packet, frame, segment, PDU, or message as described in or related to any of examples 1-24, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-24, or portions thereof.

Another example may include a computer program comprising instructions, wherein execution of the program by a processing element is to cause the processing element to carry out the method, techniques, or process as described in or related to any of examples 1-24, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying at least one limitation on autonomous retransmission for radio link control (RLC) service data units (SDUs), wherein the at least one limitation includes a maximum number of times that a same RLC SDU can be autonomously retransmitted; and
triggering autonomous retransmission of a first RLC SDU in accordance with the limitation.

2. The method of claim 1, wherein the at least one limitation further includes a maximum number of RLC SDUs of a protocol data unit (PDU) set that may be simultaneously triggered for autonomous retransmission.

3. The method of claim 1, wherein the at least one limitation further includes a maximum number of RLC SDUs that can be pending for autonomous retransmission at the same time.

4. The method of claim 1, wherein the at least one limitation further includes configuration information for a prohibit timer to control a frequency of autonomous retransmission of the RLC SDUs.

5. The method of claim 1, further comprising:
receiving an acknowledgement for the first RLC SDU after triggering autonomous retransmission of the first RLC SDU; and
cancelling the autonomous retransmission of the first RLC SDU based on the acknowledgement.

6. The method of claim 1, further comprising:
determining that a condition related to the autonomous retransmission has been satisfied; and
generating a buffer status report or a delay status report for transmission based on the determination.

7. The method of claim 6, wherein the condition includes that:
a number or a data volume of at least one RLC SDU exceeds a first threshold;
a number or a data volume of at least one delay-critical SDU exceeds a second threshold, wherein the at least one delay-critical SDU has a remaining time to discard that is less than a remaining time threshold; or
a total number or a total data volume of delay-critical SDUs and important SDUs exceeds a third threshold, wherein the important SDUs have at least a threshold importance level.

8. One or more non-transitory, computer-readable media having instructions that, when executed, cause processor circuitry to:
trigger autonomous retransmission of at least one radio link control (RLC) service data unit (SDU);
determine that a condition related to the autonomous retransmission has been satisfied; and
instruct a lower layer to trigger a buffer status report or a delay status report based on the determination.

9. The one or more non-transitory, computer-readable media of claim 8, wherein the condition includes that a number or a data volume of the at least one RLC SDU exceeds a threshold.

10. The one or more non-transitory, computer-readable media of claim 8, wherein the condition includes that a number or a data volume of at least one delay-critical SDU of the at least one RLC SDU exceeds a threshold, wherein the at least one delay-critical SDU has a remaining time to discard that is less than a remaining time threshold.

11. The one or more non-transitory, computer-readable media of claim 8, wherein the condition includes that a total number or a total data volume of delay-critical SDUs and important SDUs of the at least one RLC SDU exceeds a threshold, wherein the delay-critical SDUs have a remaining time to discard that is less than a remaining time threshold and the important SDUs have at least a threshold importance level.

12. The one or more non-transitory, computer-readable media of claim 8, wherein the instructions, when executed, further cause the processor circuitry to determine a data volume for the buffer status report or the delay status report, the data volume to include a RLC control protocol data unit (PDU) that indicates at least one RLC SDU that will no longer be retransmitted.

13. The one or more non-transitory, computer-readable media of claim 8, wherein the instructions, when executed, further cause the processor circuitry to determine a data volume for the buffer status report or the delay status report, the data volume to exclude at least one RLC SDU that will no longer be retransmitted.

14. The one or more non-transitory, computer-readable media of claim 8, wherein the instructions, when executed, further cause the processor circuitry to identify a limitation on autonomous retransmission for RLC SDUs, wherein the autonomous retransmission of at least one RLC SDU is triggered in accordance with the limitation.

15. The one or more non-transitory, computer-readable media of claim 14, wherein the limitation includes:
a maximum number of times that an RLC SDU can be autonomously retransmitted;
a maximum number of RLC SDUs of a protocol data unit (PDU) set that may be simultaneously triggered for autonomous retransmission;
a maximum number of RLC SDUs that can be pending for autonomous retransmission at the same time; or
a prohibit timer to control a frequency of autonomous retransmission of RLC SDUs.

16. The one or more non-transitory, computer-readable media of claim 8, wherein the instructions, when executed, further cause the processor circuitry to:
start a prohibit timer associated with transmission of status reports;
determine that a first RLC SDU has been discarded by a transmitter device; and
trigger, based on the determination, a first status report for the first RLC SDU for transmission prior to expiration of the prohibit timer.

17. The one or more non-transitory, computer-readable media of claim 16, wherein the first status report includes an acknowledgement for the RLC SDU.

18. An apparatus comprising:
processor circuitry to:
trigger autonomous retransmission of a radio link control (RLC) service data unit (SDU);
receive an acknowledgement for the RLC SDU after triggering the autonomous retransmission of the RLC SDU; and
cancel the autonomous retransmission of the RLC SDU based on the acknowledgement; and
interface circuitry coupled to the processor circuitry to enable communication.

19. The apparatus of claim 18, wherein the autonomous retransmission of the RLC SDU is triggered based on a determination that the RLC SDU has a time remaining until discard below a threshold.

20. The apparatus of claim 18, wherein the autonomous retransmission of the RLC SDU is based on a number of times that the RLC SDU has been autonomously retransmitted being less than a maximum number of times that a same RLC SDU can be autonomously retransmitted.
